(19) United States
(12) Patent Application Publication
(10) Pub. No.: US 2008/0278933 A1
(43) Pub. Date: Nov. 13, 2008

(54) LAMP WITH SAIL-LIKE OVERHEAD ELEMENT, PREFERABLY FOR IMPROVING ACOUSTICS, ROOM FORMATION, AND INDIRECT LIGHTING OF WORKPLACES

(75) Inventors: Jurgen GENDRIESCH, Dusseldorf (DE); Jurgen Schubert, Dusseldorf (DE); Alexander Prang, Dusseldorf (DE)

Correspondence Address: K.F. ROSS P.C., 5683 RIVERDALE AVENUE, SUITE 203 BOX 900, BRONX, NY, 10471-0900, US

(73) Assignee: StructureLab GmbH

(21) Appl. No.: 12/106,503

(22) Filed: Apr. 21, 2008

(30) Foreign Application Priority Data
May 11, 2007 (DE) 202007006799.2

(51) Int. Cl. F21S 8/04

(52) U.S. Cl. 362/147

(57) ABSTRACT

A light fixture shining light upward has a mast with a base or is attached to room or furniture systems. In order to improve the acoustics or a room, structure of a room, and/or for the indirect lighting of workplaces, a canopy element including a textile canopy and a frame stretching the textile canopy has at least one shaft-like element of the frame located eccentrically relative to the canopy, and is attached to the light-fixture mast or another part of the light fixture shining light upward.

### PRIOR ART

A light fixtures is known that shines light upward (and downward) that have a mast for the indirect (and direct) lighting of workplaces. The upwardly directed light from these light fixtures is reflected by the ceiling and generates indirect light on the workplace. These light fixtures have the disadvantage that the upwardly directed light is not reflected in high-ceilinged rooms, that the light fixtures do not improve the acoustics of the room, and that the light fixtures contribute only very little or not at all to the structure of the room.

Moreover, light fixtures are known that direct light upward having a mast and non-textile reflectors. However, due to the small reflectors required by their construction, the quality of the indirect light from light fixtures of this type is not comparable with light reflected over large surfaces via a white ceiling. These light fixtures also do not improve the acoustics of a room.

Furthermore, light fixtures are known having a mast and a textile shade. Here, the shade has the function of screening off direct light. Shades of this type are open at the top and do not reflect light shining upward.

Moreover, acoustical shades are known, normally in the form of so-called funnel shades with a central mast that is preferably placed on the floor on a stand, as are acoustical sails freely spanning a room, as well as light and acoustical elements that may be hung from the ceiling or on the wall, etc. Such systems may be used for the reflection of upwardly directed light from a light fixture, but they have the disadvantage of being unable to react to different workplace situations and configurations of tables and/or workplaces.

### PROBLEM

The object of the invention described in claim 1 is to develop a light fixture that improves room acoustics, room structure, and indirect lighting of workplaces even in high-ceilinged rooms, and by means of which it is possible to react to different workplace situations and configurations of tables and/or workplaces.

### SOLUTION

This object is attained by the features disclosed in claim 1.

### ADVANTAGES

The light fixture with the features listed in claim 1 solves and/or improves workplace situations in many respects: the optical reflection properties of the textile canopy of the ceiling element create an indirect illumination portion. The acoustic properties, in particular the acoustic absorption properties of the textile canopy of the ceiling element improve, in particular, reduce, the reverberation period. The canopy element has a space-structuring effect in that it partially or completely covers workplace configurations.

The light fixture with the features listed in claim 1 is able to react in a simple and individual fashion to changing workplace configurations. By virtue of the minimal weight of the sail-like canopy as well as the eccentric position of the shaft element, it may be favorably set up in the space in a flexible and modular fashion or attached to furniture systems and equipped with one or more adjustable-height and rotatable canopy elements. In this context, “eccentric” means that the shaft-like element, as long as it has a vertical orientation, is located outside the area of the canopy with regard to its footprint.

The light fixture with the features listed in claim 1 may be able to make a significant contribution to a reduction in construction and operating costs: acoustic measures such as acoustical ceilings may be entirely or partially omitted. Wiring in the ceiling, especially for suspended light fixtures, may be partially or completely omitted. Electricity use may be reduced by the targeted illumination of local workplace configurations. In the case of changes to the structure or the room, the light fixtures may be easily moved. Furniture measures for the division and/or marking of workplace configurations may be partially or completely omitted.

### DESCRIPTION OF THE DRAWINGS

Embodiments will be described with reference to FIGS. 1 to 8:

FIG. 1 shows the main claim of the patent.

FIGS. 1a-b

FIG. 1 shows a light fixture 41 projecting light upward and having a light fixture mast 42 to which a canopy module including a textile canopy 11 and a frame stretching the canopy 11 is secured by two clamping or connector elements 22. Instead of two, one or more clamping or connector elements 22 may also be used. The frame of the modular canopy module includes the shaft-like element 1 located eccentrically relative to the textile canopy 11 that, after a bend on the upper end, transitions into a truss element 2. On this truss element, a central pivot point 7 is located to which the arms 3 stretching the canopy 11 are linked. The outer ends of the arms are connected via a tie element/pull rope 4, so that the canopy 11 may also be stretched particularly well. In this case, the canopy is stretched between the ends of the arms 3, the shaft-like element 1, and the end of the truss element 2 and is characterized by an inversely bowed, three-dimensional shape.

FIGS. 2 to 8 show additional advantageous variant embodiments and other examples:

FIGS. 2a-b

FIG. 2 shows how two canopy modules are attached to the light fixture mast 42 via two clamping or connector elements 22.

FIG. 3

FIG. 3 shows a light fixture 41 with canopy elements whose light fixture mast 42 is attached to room or furniture systems 31-32.

FIGS. 4a-f

FIG. 4 shows possible embodiments of clamping or connector elements 22 for fastening one or two shaft-like elements 1 of canopy elements to the light fixture mast 42. The clamping or connector elements 22 may be attached to the light fixture mast 42 at any desired height and in any desired direction; in other words, they are mountable such that they may be ideally rotated and adjusted in height.

FIG. 5

FIG. 5 shows a possible construction of the shaft-like element 1 out of multiple sections. In this variant embodiment, the canopy 11 is stretched by a frame-like structure 6.

FIG. 6a-d

FIG. 6 shows additional variant of the canopy element of the light fixture in which the canopy element is arranged centrally above the lighting head 43. The shaft-like element 1 runs from its attachment to the light fixture mast 42 initially outward and then transitions with an arc into the truss element 2. The truss element 2 follows the course of the inversely bowed textile canopy 11 in that it has a bend at the central pivot point 7, the attachment point for the arms 3.

FIGS. 7a-d

FIG. 7 shows additional variant embodiments of the canopy element of the light fixture. From its attachment to the light fixture mast 42, the shaft-like element 1 runs vertically upward and then transitions with an arc into the truss element 2. The truss element 2 follows the course of the inversely bowed textile canopy 11 in that it has a bend at the central pivot point 7, the attachment point for the arms 3.

FIGS. 8a-v

FIG. 8 shows additional variant embodiments of the canopy element of the light fixture.

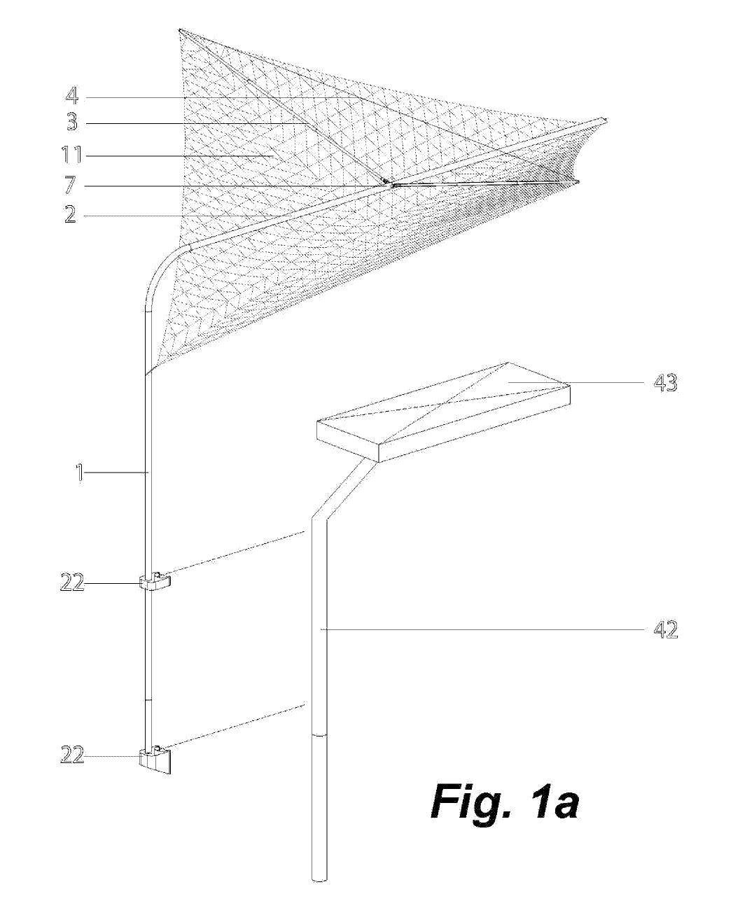

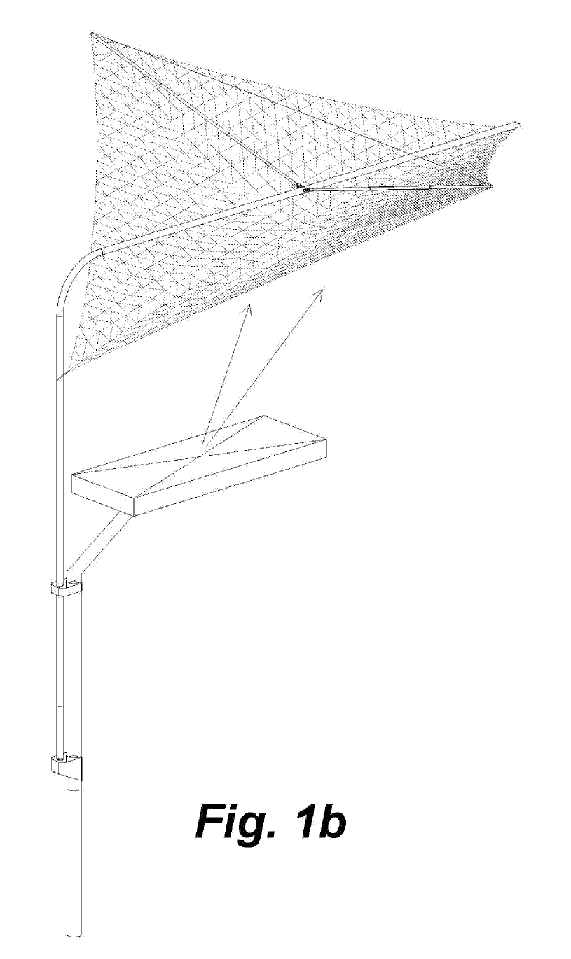

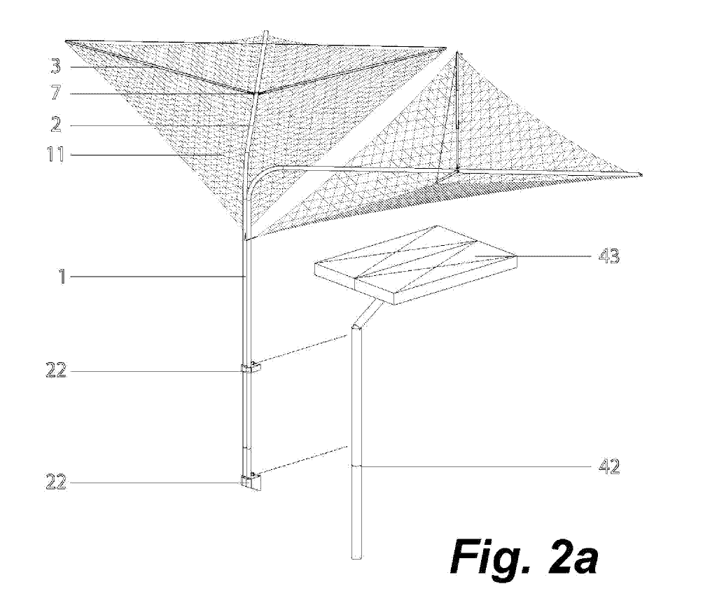

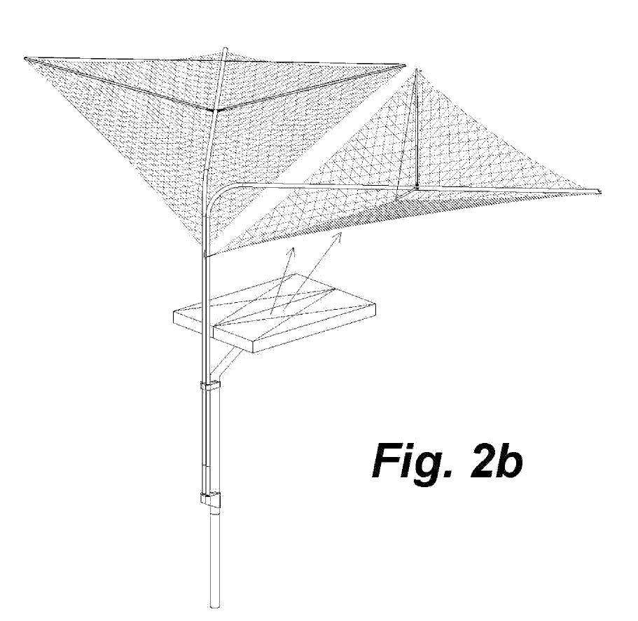

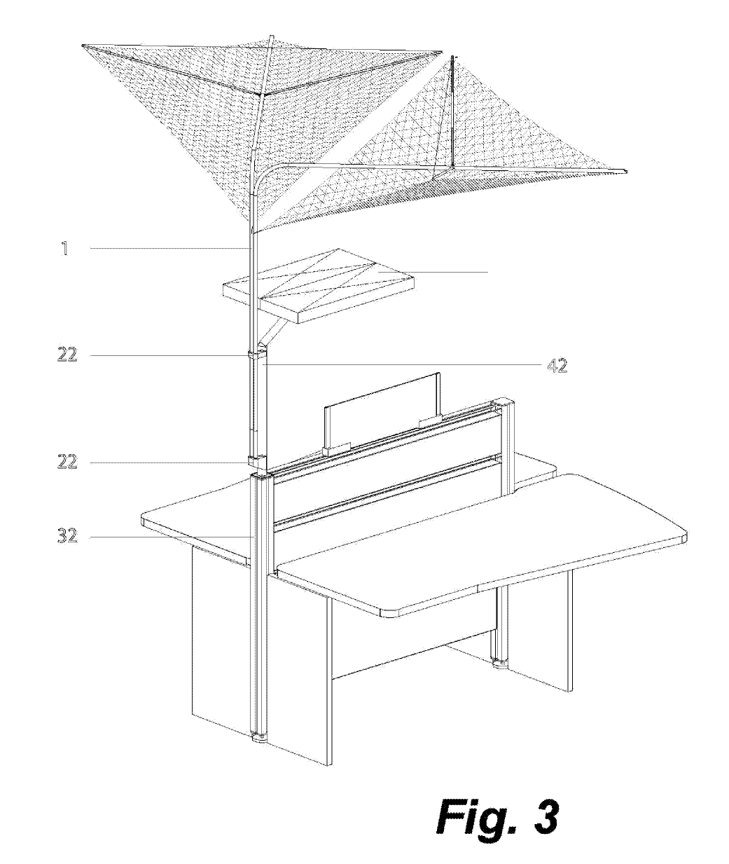

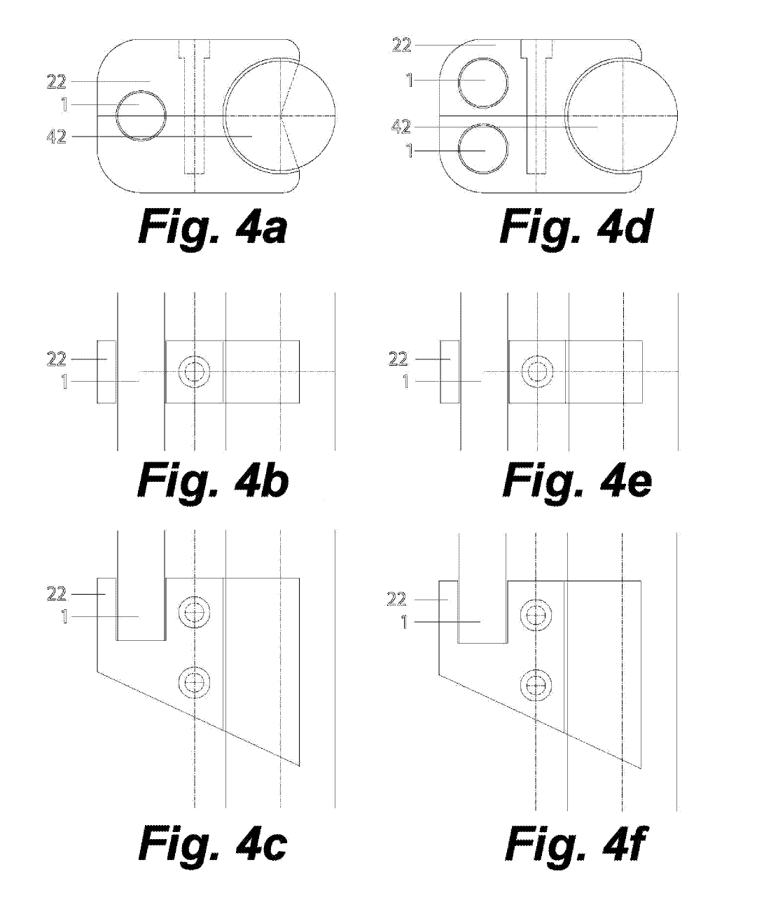

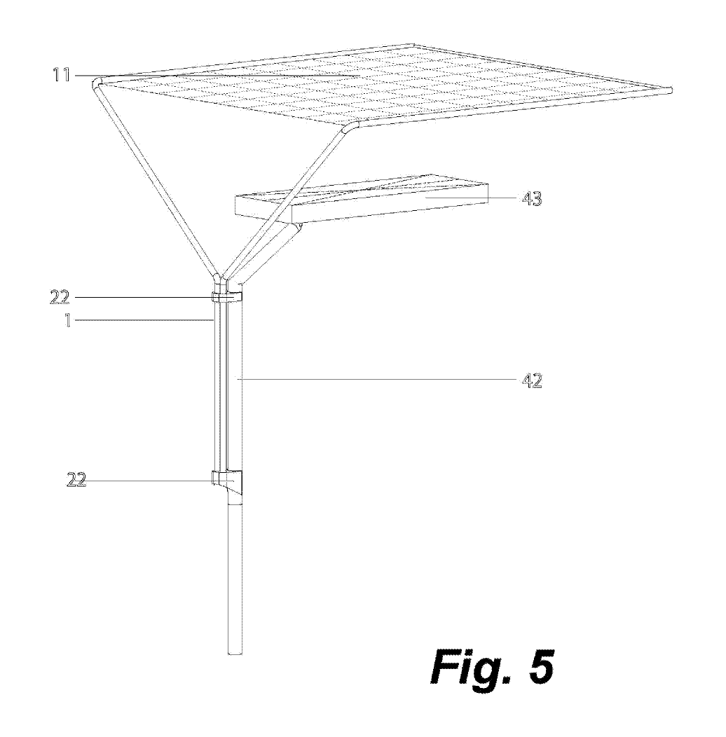

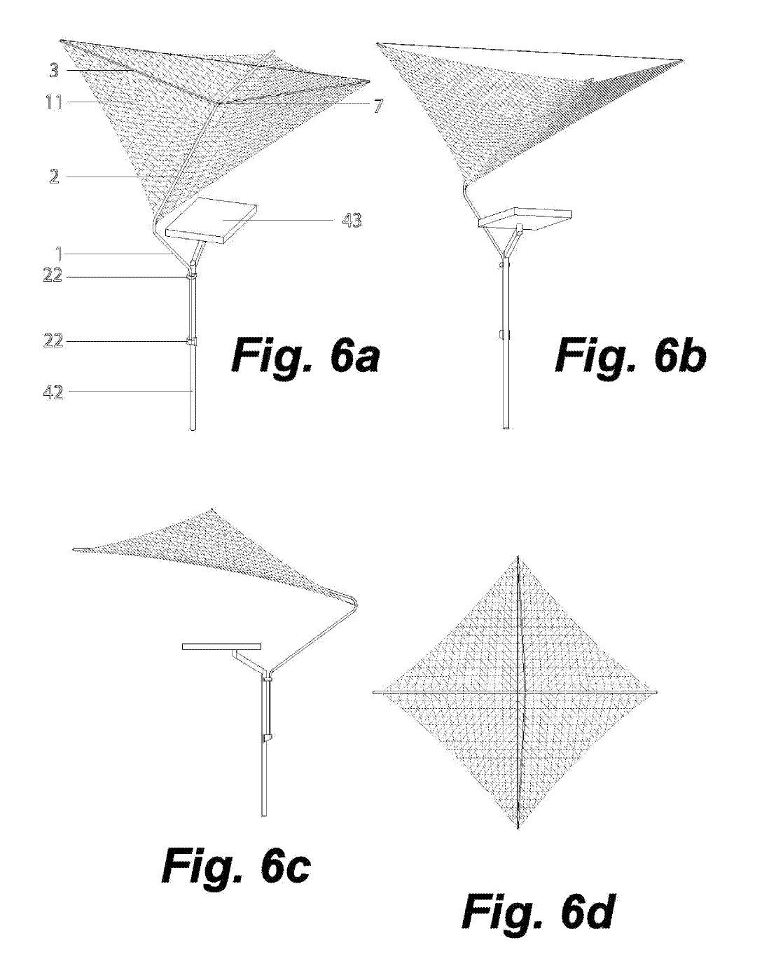

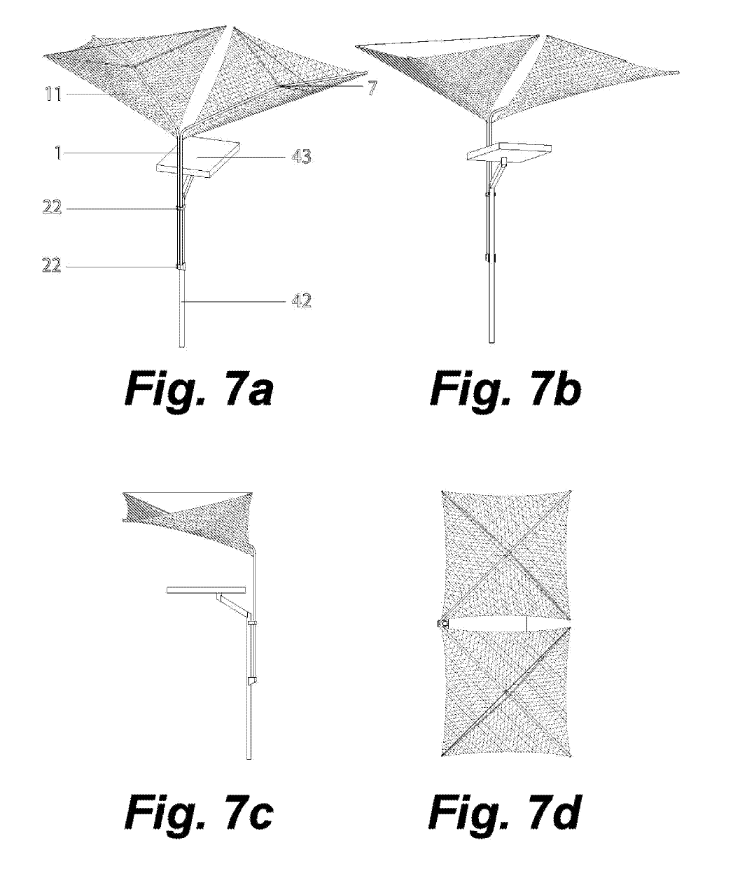

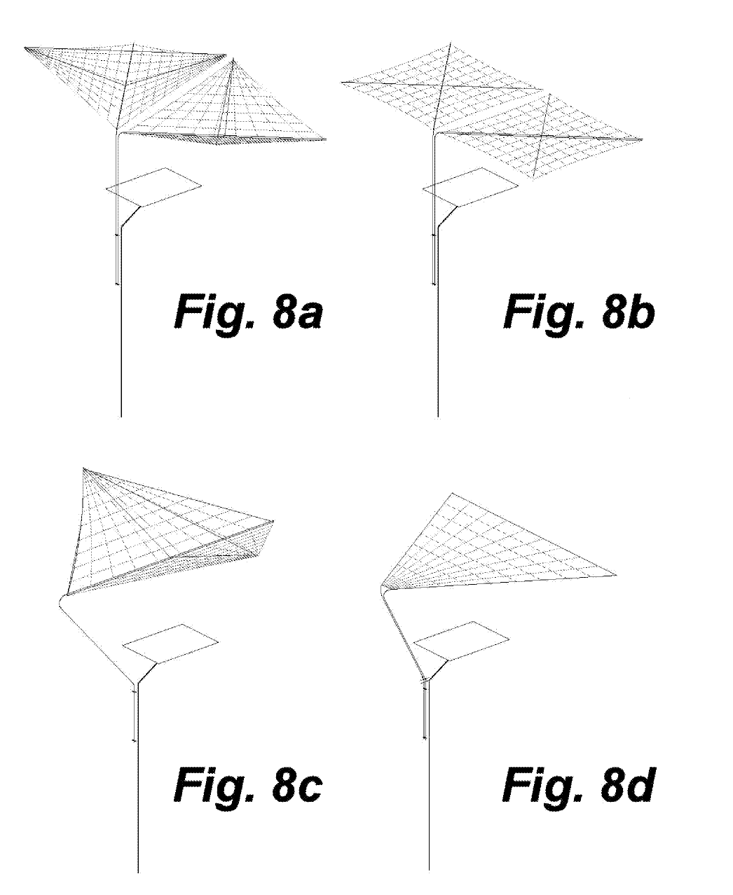

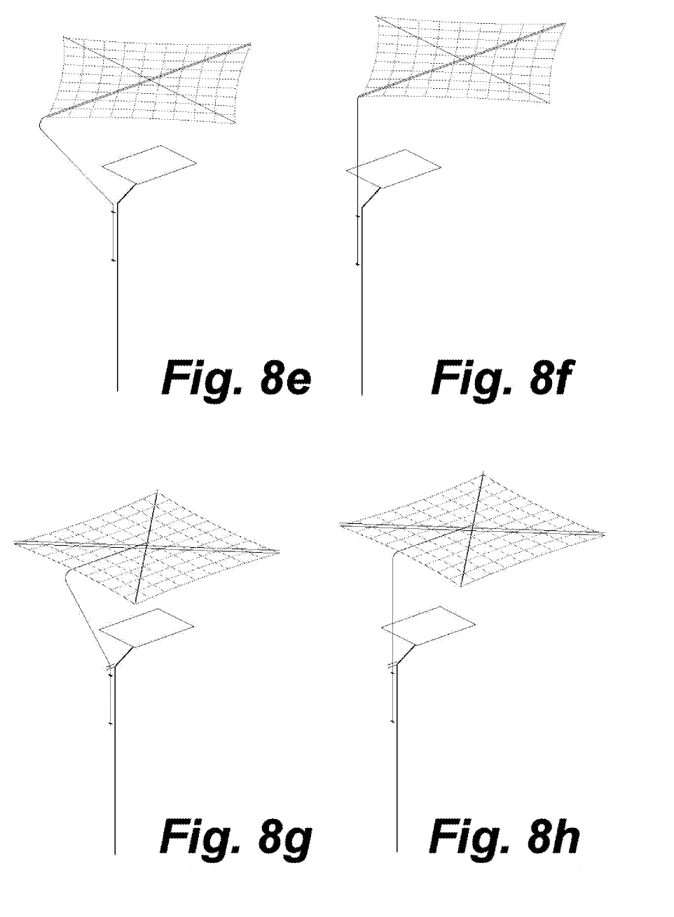

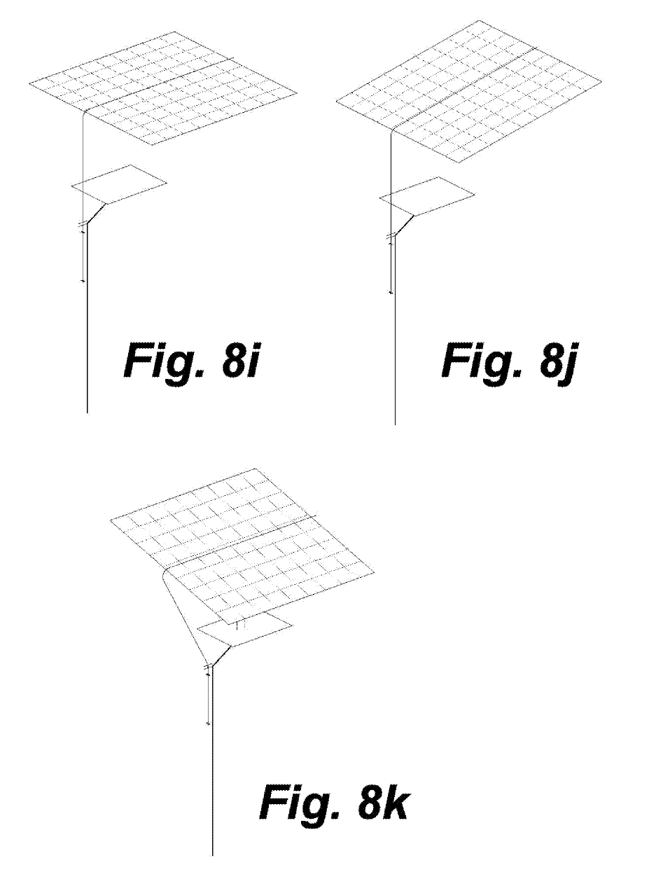

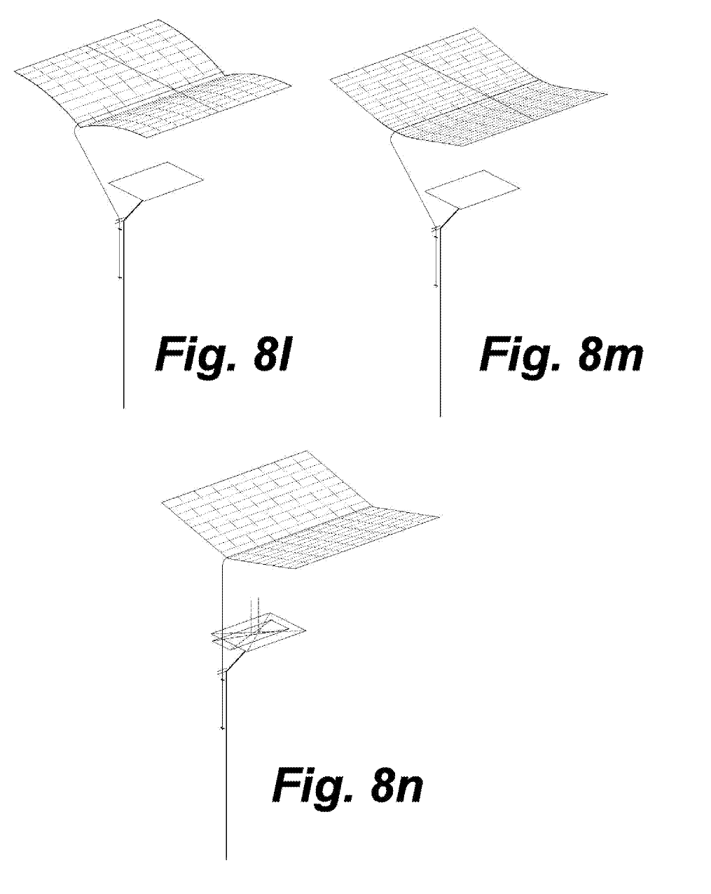

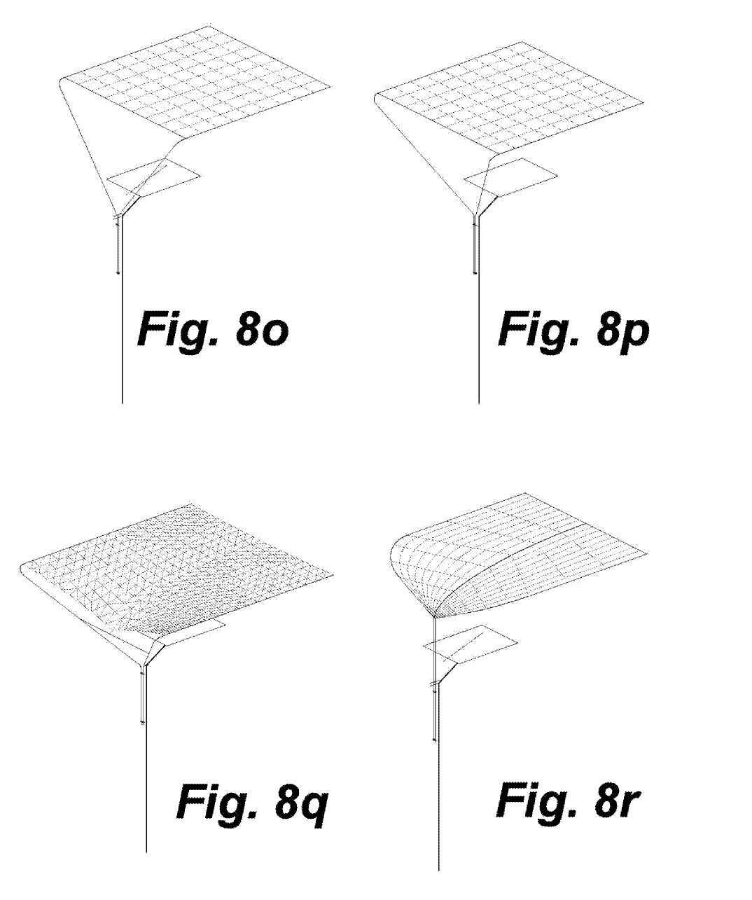

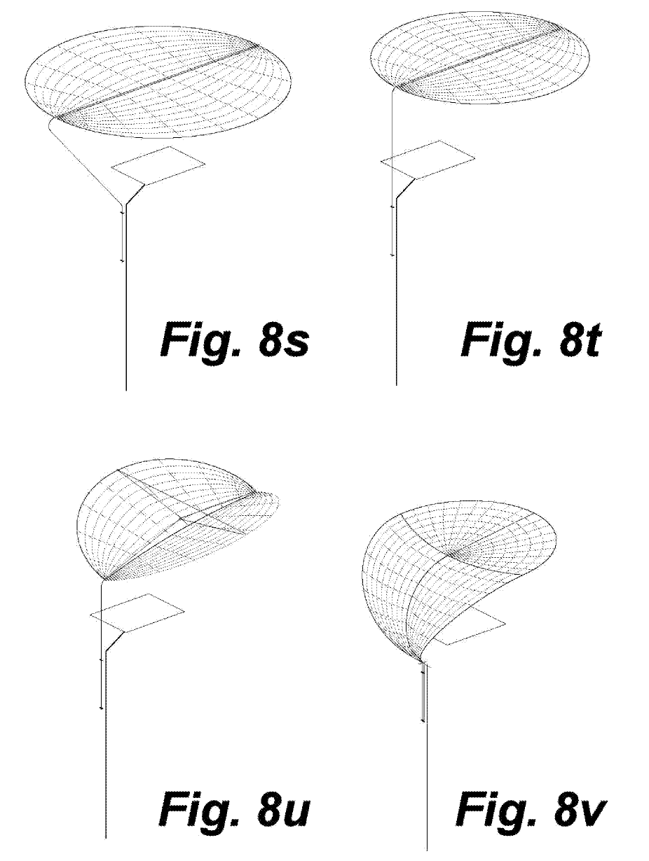

### LIST OF REFERENCE CHARACTERS

### Frame

1 Shaft-like element
2 Truss element
3 Arms
4 Pull rope
6 Frame-like structure
7 Central pivot point

### Canopy

11 Canopy
12 Fastening points for the canopy

### Holder

21 Stand
22 Clamping element
23 Adapter element
24 Receiving point

### Furniture Systems

31 Table plate
32 Support or connection element for table plates, room systems, or furniture systems
41 Light fixture
42 Light fixture mast
43 Lighting head

1. A light fixture shining light upward having a mast that has a base or is attached to room or furniture systems wherein, in order to improve the acoustics or a room, structure of a room, and/or for the indirect lighting of workplaces, a canopy element, including a textile canopy and a frame stretching the textile canopy, having at least one shaft-like element of the frame located eccentrically relative to the canopy, is attached on the light fixture mast or another part of the light fixture shining light upward.

2. The light fixture according to claim 1 wherein the holder is built onto the light fixture in such a way that it has multiple receiving points for the shaft-like element that is located eccentrically relative to the canopy and therefore a plurality of canopy elements may be attached.

3. The light fixture according to claim 1 wherein the canopy element of the light fixture is attached in such a way that its height may be adjusted or it may be rotated.

4. The light fixture according to claim 1 wherein the shape of the canopy extending over the light fixture is polyqonal with at least three sides.

5. The light fixture according to claim 1 wherein the canopy extending over the light fixture describes an two-dimensional flat surface or a three-dimensional inversely bowed surface.

6. The light fixture according to claim 1 wherein the canopy extending over the light fixture is stretched freely at corners over a frame-like structure.

7. The light fixture according to claim 1 wherein the canopy extending over the light fixture may have regions of different degrees of transmission and reflection.

8. The light fixture according to claim 1 wherein the canopy extending over the light fixture has a truss element to which other structural support arms may be attached or linked.

9. The light fixture according to claim 1 wherein the shaft-like element of the canopy element of the light fixture is composed of one or more slats.

10. The light fixture according to claim 1 wherein the shape of the canopy extending over the light fixture has a round or oval footprint.

11. The light fixture according to claim 1 wherein the canopy element of the light fixture may be removed from the mast or from other parts of the light fixture and may be set up on a table plate with a stand/base plate via a shaft-like element that is eccentric relative to the canopy.

12. The light fixture according to claim 1 wherein the canopy element of the light fixture may be removed from the mast or from other parts of the light fixture and may be attached by means of a corresponding clamping element or adapter element to a table plate or to the support or connector of table plates, room systems, or furniture systems.
